(19) United States
(12) Patent Application Publication
(10) Pub. No.: US 2011/0008093 A1
(43) Pub. Date: Jan. 13, 2011

(54) Writing/marking implement holder

(76) Inventors: John Treacy, Port Chester, NY (US); Robert A. Hluboky, JR., Port Chester, NY (US); Jeffrey M. Saresky, Port Chester, NY (US)

Correspondence Address: LITMAN LAW OFFICES, LTD., PATENT LAW BUILDING, 8955 CENTER STREET, MANASSAS, VA, 20110, US

(21) Appl. No.: 12/585,284

(22) Filed: Sep. 10, 2009

Related U.S. Application Data
(60) Provisional application No. 61/213,713, filed on Jul. 7, 2009.

(51) Int. Cl. B43K 23/00; A44C 5/00

(52) U.S. Cl. 401/131; 224/219

(57) ABSTRACT

The writing/marking implement holder has a cushioned strap that houses a reel. A is tether extendable from the reel, which tether is attached to a receptacle. The receptacle is adapted for frictionally or resiliently gripping and retaining one end of the writing or marking implement. When needed, the implement is pulled to extend the tether from the reel. After writing or marking, the tether is coiled upon the reel to draw the writing or marking implement back to a retracted position adjacent the wrist. The reel is preferably spring-biased.

### CROSS-REFERENCE TO RELATED APPLICATION

This application claims the benefit of U.S. Provisional Patent Application Ser. No. 61/213,713, filed Jul. 7, 2009.

### BACKGROUND OF THE INVENTION

1. Field of the Invention

The present invention generally relates to writing instruments, and particularly to a writing/marking implement holder for supporting a writing or marking instrument on the wrist of a user.

2. Description of the Related Art

Many, many people utilize writing or marking instruments in their everyday endeavors to accomplish desired or needed tasks. Delivery persons, contractors, artists, clerks (the list is endless) all require an instrument such as a pen, pencil or marker to perform essential functions. As fate would have it, the needed instrument is easily misplaced and must be located before the desired writing or marking tasks can be accomplished. Inserting the instrument in one's pocket or lodging it behind the ear sometimes solves the problem. However, it is often forgotten to store the instrument in those places. Aside from the frustration and consternation, the time spent in locating the instrument reduces efficiency, which could lead to financial losses. The art would certainly welcome a simple apparatus for storing the aforementioned instrument for instant retrieval, which apparatus could be removably attached to the user. Thus, a writing/marking implement holder solving the aforementioned problems is desired.

### SUMMARY OF THE INVENTION

The writing/marking implement holder is an apparatus that is removably attached to the wrist of a user. The apparatus includes a cushioned strap, a tether, and a writing/marking instrument receptacle. A housing member is positioned on the strap and is connected to the receptacle via a flexible cable or tether. The tether is attached to the receptacle and can be extended from or retracted onto a reel inside the housing. The receptacle is adapted to retain a writing/marking instrument therein.

Accordingly, the invention presents apparatus for retaining a writing or marking instrument, which can be easily and comfortably attached to the wrist of a user. The writing or marking instrument can be conveniently extracted from and/or retracted into the apparatus while attached thereto. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a writing/marking implement holder according to the present invention.

FIG. 2 is a perspective view of a writing/marking implement holder according to the present invention.

FIG. 3 is a partial section view of a writing/marking implement holder according to the present invention.

Similar reference characters denote corresponding features consistently throughout the attached drawings.

### DETAILED DESCRIPTION OF THE PREFERRED EMBODIMENTS

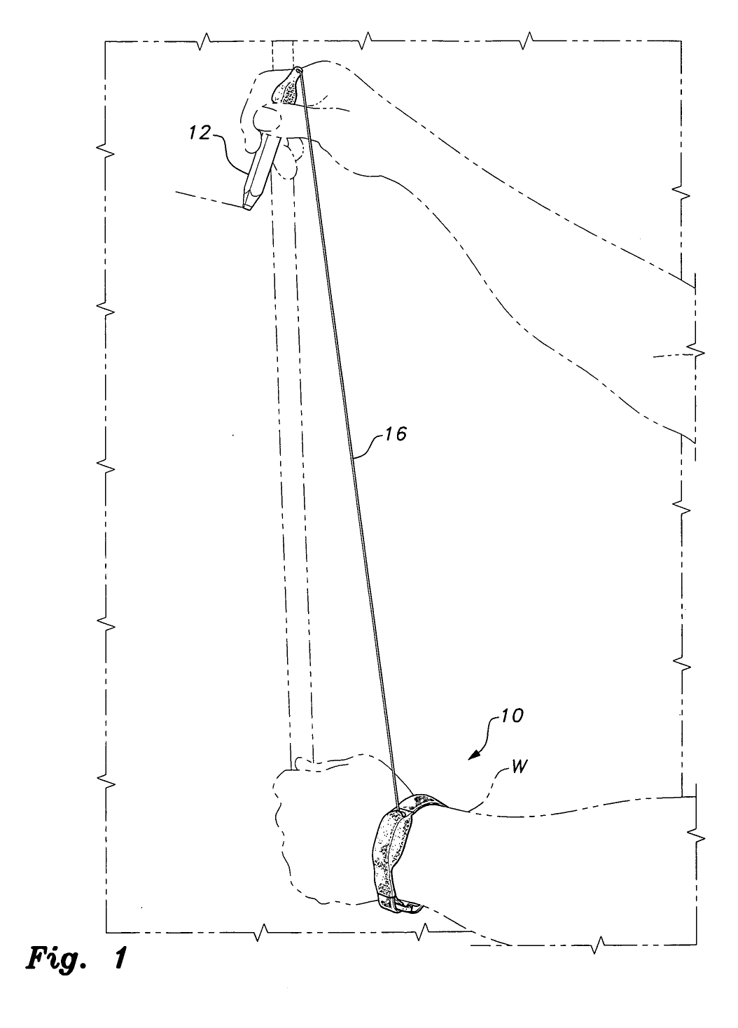

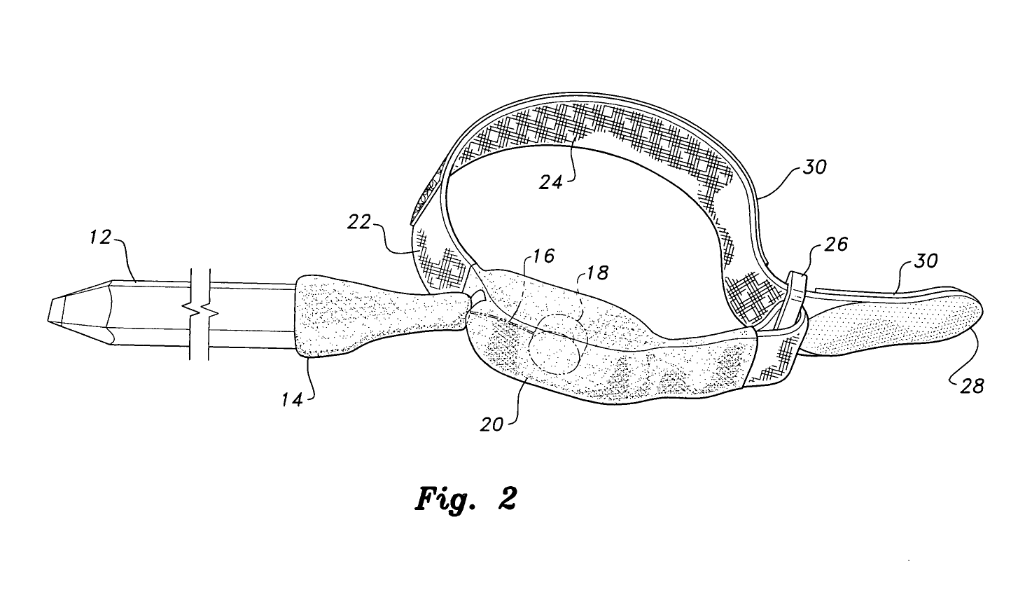

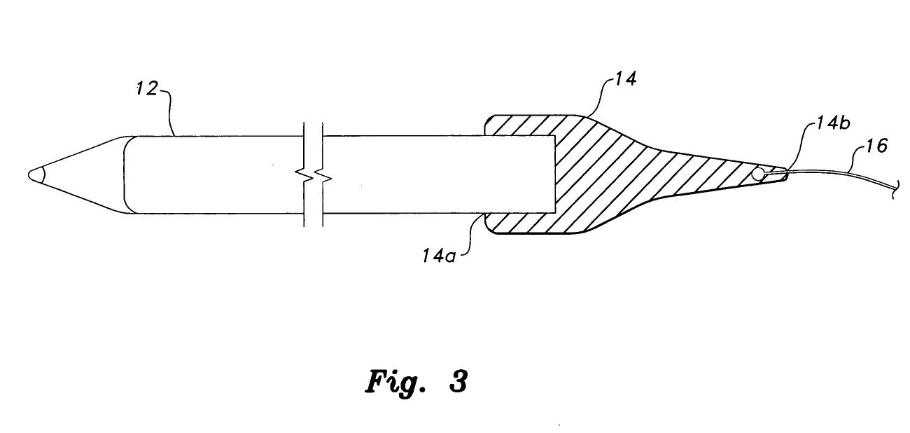

Referring to FIGS. 1-3, the writing/marking implement holder is generally indicated at 10. The apparatus is adapted to be worn on the wrist W of a user. The writing/marking implement 12 is illustrated as a pencil. However, the implement can take the form a pen, stylus, felt marker, etc. Implement 12 is frictionally or resiliently retained in a receptacle 14. Receptacle 14 is fabricated from a durable, flexible material (plastic, hard rubber, etc.), which may be elastic or resilient, and is of a substantially conical configuration. Receptacle 14 defines an opening 14a at a proximate end thereof for receiving the distal end of the implement 12 therein. The opposite end 14b of receptacle 14 is attached to one end of a flexible cable 16 or other tether. Cable 16 can be made from any suitable material (metal, nylon, etc.). The other end of cable 16 is attached to a conventional reel apparatus 18 (shown in phantom lines in FIG. 2), which may be spring-biased to automatically retract the cable 16 onto the reel 18 that is enclosed in a housing 20. Housing 20 is attached to a wrist strap 22. Wrist strap 22 comprises an inner surface 24 fabricated from a soft, moisture-absorbent, cushioning material for comfortable wear. A ring, loop, or buckle 26 is disposed at one end of the strap 22. The other end 28 of the strap 22 is a free end. Mating hook and loop fasteners 30 are strategically disposed on the outer surfaces of strap 22. The free end of the strap 22 is drawn through the buckle 26 and folded back over the buckle 26 to secure the mating strips of hook and loop fasteners 30 so that the strap may be easily and continuously adjusted to fit wrists of different sizes.

In use, a desired implement is positioned in the receptacle 14 and the strap 22 is secured to the wrist W. When needed, the cable 16 can be extended from the housing 20 so that the implement 12 can be used to perform a writing or a marking chore. After use, the cable 16 is retracted to draw the implement 12 back to a position adjacent the housing 20. Thus, the implement 12 is always available.

It is to be understood that the present invention is not limited to the embodiment described above, but encompasses any and all embodiments within the scope of the following claims.

We claim:

1. A writing/marking implement holder, comprising:
a wrist strap having an inner surface and an outer surface;
a soft cushioning material disposed on the inner surface of the wrist strap;
a housing positioned on the wrist strap;
a reel device enclosed in the housing;
a flexible tether having a proximate end and a distal end, the proximate end being attached to the reel; and
a receptacle adapted for retaining a writing/marking implement therein, the receptacle being attached to the distal end of the tether.

2. The writing/marking implement holder according to claim 1, wherein said receptacle defines an opening adapted for receiving an end of the implement.

3. The writing/marking implement holder according to claim 1, wherein said receptacle is fabricated from resilient material for frictionally retaining the implement therein.

4. The writing/marking implement holder according to claim 1, wherein said receptacle defines an opening adapted for receiving an end of the implement and wherein said receptacle is fabricated from resilient material for frictionally retaining the implement therein.

5. The writing/marking implement holder according to claim 1, wherein said soft cushioning material comprises a moisture-absorbent material.

6. A writing/marking implement holder, comprising:
a wrist strap having an inner surface, an outer surface, a first end and a second end;
a buckle disposed at the first end of the wrist strap, the second end terminating as a free end;
a soft cushioning material disposed on the inner surface of the wrist strap;
a housing positioned on the wrist strap;
a reel device enclosed in the housing;
a flexible tether having a proximate end and a distal end, the proximate end being attached to the reel; and
a receptacle adapted for retaining a writing/marking implement therein, the receptacle being attached to the distal end of the tether.

7. The writing/marking implement holder according to claim 6, further including hook and loop fasteners positioned on the free end and the outer surface of said wrist strap.

8. The writing/marking implement holder according to claim 6, wherein said receptacle defines an opening adapted for receiving an end of the implement and wherein said receptacle is fabricated from resilient material for frictionally retaining the implement therein.

9. The writing/marking implement holder according to claim 6, wherein said soft cushioning material comprises a moisture-absorbent material.
